(19) United States
(12) Patent Application Publication
(10) Pub. No.: US 2002/0154445 A1
(43) Pub. Date: Oct. 24, 2002

(54) Suspension and head gimbal assembly

(76) Inventors: Takeshi Wada, Tokyo (JP); Masashi Shiraishi, Hong Kong (HK); Norikazu Ota, Tokyo (JP); Takashi Honda, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/060,401

(22) Filed: Feb. 1, 2002

(30) Foreign Application Priority Data
Feb. 9, 2001 (JP) 33394/2001

(51) Int. Cl. G11B 5/48

(52) U.S. Cl. 360/244.1; 360/244.2

(57) ABSTRACT

An HGA includes a magnetic head slider with at least one thin-film magnetic head element, a drive IC chip with a circuit for the at least one thin-film magnetic head element, a resilient flexure made of a stainless steel for supporting the magnetic head slider and the drive IC chip, a load beam made of a high-thermal-conductivity material with a higher thermal conductivity than that of the stainless steel, supporting the flexure, a base plate, and a hinge made of a stainless steel, fixed to a base section of the load beam and to the base plate, for applying a predetermined load to the magnetic head slider.

### FIELD OF THE INVENTION

The present invention relates to a suspension used in for example a hard disk drive (HDD) apparatus and for supporting a drive IC chip for a thin-film magnetic head element, and to head gimbal assembly (HGA) with the suspension.

### DESCRIPTION OF THE RELATED ART

In such HDD apparatus, the thin-film magnetic head element for writing magnetic information into and/or reading magnetic information from a magnetic disk is in general formed on a magnetic head slider flying in operation above a rotating magnetic disk. The slider is fixed at a top end section of the suspension.

Recently, recording frequency in the magnetic disk rapidly increases to satisfy the requirement forever increasing data storage capacities and densities in today's HDDs. In order to realize higher frequency recording, proposed is a chip-on-suspension structure of an HGA with a suspension for supporting both a slider and a drive IC chip of a driver circuit for the magnetic head element. According to this structure, since the length of lead lines from the driver circuit to the magnetic head element can be shortened, generation of unnecessary noises from the lead lines can be effectively suppressed resulting high frequency recording characteristics to improve. Also, it is possible to amplify a very faint output signal provided from a magnetoresistive effect (MR) read head element at a nearer position to the MR head element.

The drive IC chip used in such chip-on-suspension structure HGA is required to extremely downsize due to its mounting configuration. If the drive IC chip is so downsized, its surface area becomes greatly small causing extremely insufficient thermal radiation. Because a writing current flowing through the drive IC chip during recording operation is very large, this insufficient heat radiation of the drive IC chip will become a significant problem. In addition, since the drive IC chip is mounted on a suspension with a very small mounting space and also an electrical characteristics of the drive IC chip will be deteriorated due to noises caused by floating capacitance of its lead terminals at a higher frequency more than 500 MHz, it is necessary to fabricate the drive IC chip as a bare IC chip. Thus, the heat radiation performance of the drive IC chip will more decrease and a chip temperature will dependently increase.

Usually, a spring member of a suspension is formed by a leaf spring of a stainless steel. However, since the stainless steel has a lower thermal conductivity in comparison with that of other metal material and the stainless steel suspension is formed in a quite thin thickness, a sufficient thermal radiation effect cannot be expected when the suspension of the chip-on-suspension structure HGA is mainly made of the stainless steel.

As aforementioned, according to the conventional HGA with the chip-on-suspension structure has the following problems:

(1) Since the drive IC chip is extremely thin and small and therefore has a small surface area, it is difficult to effectively radiate a heat generated by itself;

(2) Since a stainless steel generally used for the spring member of the suspension has a relatively low thermal conductivity and an extremely thin thickness, no sufficient thermal radiation effect can be expected if the HGA is configured with a normal chip-on-suspension structure;

(3) Since the drive IC chip is mounted on a surface of the suspension, which is faced to a magnetic recording medium, it is difficult to attach a thermal radiation mechanism directly to the drive IC chip itself; and

(4) Due to excellent functions of the stainless steel for the suspension, it is difficult now to find alternative material.

If no heat generated is sufficiently radiated from the drive IC chip and thus the temperature of the drive IC chip highly increases, not only operations of the drive IC chip becomes unstable but also a thermal deformation of the suspension member may occur.

### SUMMARY OF THE INVENTION

It is therefore an object of the present invention to provide a suspension and an HGA, whereby more effective heat radiation of a drive IC chip can be expected.

According to the present invention, a suspension includes a resilient flexure made of a stainless steel for supporting a magnetic head slider with at least one thin-film magnetic head element and a drive IC chip with a circuit for the at least one thin-film magnetic head element, a load beam made of a high-thermal-conductivity material with a higher thermal conductivity than that of the stainless steel, supporting the flexure, a base plate, and a hinge made of a stainless steel, fixed to a base section of the load beam and to the base plate, for applying a predetermined load to the magnetic head slider.

Also, according to the present invention, an HGA includes a magnetic head slider with at least one thin-film magnetic head element, a drive IC chip with a circuit for the at least one thin-film magnetic head element, a resilient flexure made of a stainless steel for supporting the magnetic head slider and the drive IC chip, a load beam made of a high-thermal-conductivity material with a higher thermal conductivity than that of the stainless steel, supporting the flexure, a base plate, and a hinge made of a stainless steel, fixed to a base section of the load beam and to the base plate, for applying a predetermined load to the magnetic head slider.

The load beam for supporting the flexure on which the drive IC chip is to be mounted or mounted is made of a high-thermal-conductivity material with a higher thermal conductivity than that of the stainless steel. Thus, not only a thermal capacity of the suspension can be increased but also heat generated from the drive IC chip can be transferred through this load beam made by a high-thermal-conductivity material and widely dissipated resulting the drive IC chip to effectively cool. Therefore, the temperature of the drive IC chip itself can be decreased and also elevation of the local temperature of the suspension around the drive IC chip can be suppressed. As a result, a stable operation of the drive IC chip can be expected, a thermal deformation of the suspension can be prevented, and a serious heat effect to the thin-film magnetic head element can be prevented. Furthermore, due to the functions of the hinge, a mechanical characteristics as for the suspension can be maintained without deterioration.

It is preferred that the high-thermal-conductivity material is a metal material containing one of an aluminum, a copper, a magnesium, an aluminum alloy, a copper alloy and a magnesium alloy.

Further objects and advantages of the present invention will be apparent from the following description of the preferred embodiments of the invention as illustrated in the accompanying drawings.

### BRIEF DESCRIPTION OF THE DRAWINGS

FIG. 1 shows an oblique view schematically illustrating a structure of an HGA in a preferred embodiment of the present invention; and

FIG. 2 shows an exploded oblique view illustrating the HGA in the embodiment of FIG. 1.

### DESCRIPTION OF THE PREFERRED EMBODIMENTS

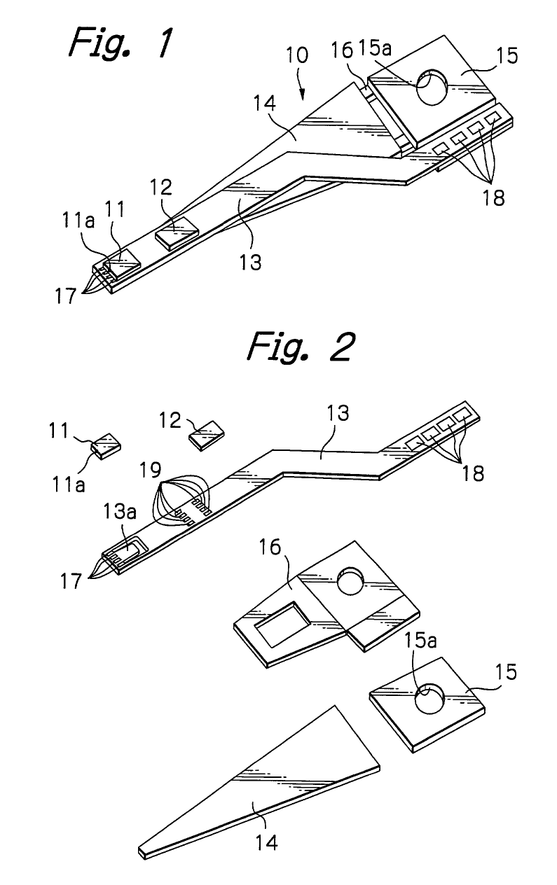

FIG. 1 schematically illustrates a structure of an HGA in a preferred embodiment of the present invention, and FIG. 2 illustrates the HGA of FIG. 1.

As shown in these figures, the HGA is assembled by fixing a magnetic head slider 11 having at least one thin-film magnetic head element to a top end section of a suspension 10, and by mounting a drive IC chip 12 for driving the head element and for amplifying a read-out signal from the head element, on a middle section of this suspension 10. The slider 11 and the drive IC chip 12 are fixed on a surface of the suspension 10, which will face to the magnetic disk surface in operation. This surface of the suspension is called hereinafter as a slider-attached surface.

The suspension 10 is substantially constituted by a resilient flexure 13 which carries the slider 11 at its top end section and supports the drive IC chip 12 at its middle section, a load beam 14 that supports and fixes the flexure 13, a base plate 15, and a resilient hinge 16 coupling a base end section of the load beam 14 and the base plate 15.

The magnetic head slider 11 has the at least one thin-film magnetic head element consisting of a write head element and an MR read head element. Although it is a mere example, the size of the magnetic head slider 11 is 1.25 mm×1.0 mm×0.3 mm.

In the drive IC chip 12, an integrated head amplifier constituting of the drive circuit and the read-out signal amplifying circuit is formed. Although it is a mere example, the size of the IC chip 12 is 1.4 mm×1.0 mm×0.13 mm. Thus, the drive IC chip 12 is very small in size and thin in thickness.

The flexure 13 has a flexible tongue 13a depressed by a dimple (not shown) formed on the load beam 14 and has elasticity for flexibly supporting by this tongue 13a the magnetic head slider 11 to provide a free attitude to the slider. The flexure 13 is made of in this embodiment a stainless steel plate (for example SUS304TA) with a thickness of about 20-25 μm and a substantially constant width.

On the flexure 13, directly formed is a thin-film pattern by a known method similar to the patterning method of forming a printed circuit board on a thin metal plate. The thin-film pattern constitutes a plurality of lead lines or trace conductors and connection pads as a lead conductor member. One ends of the trace conductors are connected to head connection pads 17 that will be connected to terminal electrodes of the magnetic head slider 11 formed at on end section (top end section) of the flexure 13, and the other ends thereof are connected to external connection pads 18 formed at the other end section (rear end section) of the flexure 13. At the middle of the trace conductors, connection pads 19 for the drive IC chip 12 are formed.

The load beam 14 has a shape with a width that narrows with approaching to its top end. This load beam 14 is a plate member made of a material with a higher thermal conductivity than that of the stainless steel, and is formed by an Al (aluminum) plate in this embodiment.

It is desired that the high-thermal-conductivity plate member 14 is made of Al that has a very high thermal conductivity, a light weight and a high corrosion resistance. However, any plate member made of metal material containing one of Al (aluminum), Cu (copper), Mg (magnesium), Al alloy, Cu alloy and Mg alloy may be used.

The hinge 16 has elasticity to supply a load to the load beam 14 for depressing the slider 11 through the flexure 13 toward the direction of a magnetic disk in operation so as to provide a stable flying height. This hinge 16 is made of in this embodiment a resilient stainless steel plate with a thickness of about 40-70 μm.

The base plate 15 is made of a stainless steel plate with a thickness larger than that of the load beam 14. The HGA will be attached to each support arm (not shown) by mechanically swaging an attachment part 15a of the base plate 15 to the support arm.

Fixing of the flexure 13 to the load beam 14, fixing of the load beam 14 to the hinge 16 and fixing of the hinge 16 to the base plate 15 are performed by spot welding at a plurality of points using a laser beam for example.

As mentioned before, at the middle section of the flexure 13, the drive IC chip 12 is mounted on the slider-attached surface of the flexure 13.

The drive IC chip 12 is a bare chip and flip-chip bonded by gold balls for example to the IC-chip connection pads 19 formed on an insulation material layer made of polyimide as the thin-film pattern made or attached on the flexure 13. In a space between the bottom of the drive IC chip 12 and the thin-film pattern, an underfill layer is filled for improving the heat radiation performance, for improving mechanical strength and for covering a part of the drive IC chip 12.

Although the drive IC chip is extremely small and thin, it generates a great deal of heat due to a large write current of several tens mA flowing there through. According to the conventional structure suspension, this generated heat exerts an influence upon not only the drive IC chip itself but also the MR head element, and partially heats the stainless steel of the flexure and the load beam which constitute spring members of the suspension. The drive IC chip may be somewhat cooled by an air flow due to the rotation of the magnetic disk. However, because of the extremely small surface area of the drive IC chip, a large air cooling effect cannot be expected. Furthermore, since a clearance between the drive IC chip and a surface of the magnetic disk is very small and no contact of the drive IC chip to the disk surface is permitted, it is difficult to make some countermeasure mechanism for enhancing the air cooling effect on the drive IC chip.

Therefore, in the conventional structure suspension, the generated heat of the drive IC chip is transferred to the suspension via its terminal electrodes made of a gold or a solder but hardly transferred and thus hardly radiated in the suspension that has a low-thermal-conductivity causing only this local area of the suspension to be heated high temperature.

Whereas according to this embodiment, since the load beam 14 located to cover a region that includes at least a position at which the drive IC chip 12 is mounted is made of the Al plate or the high-thermal-conductivity plate member, heat generated from the drive IC chip 12 can be transferred through the whole area of the load beam 14 of Al plate and widely dissipated resulting the drive IC chip 12 to effectively cool. Also, since this load beam 14 of Al plate itself functions as a heat sink so as to increase a thermal capacity of the suspension, cooling of the drive IC chip 12 is promoted in this aspect.

In fact, it is experimentally confirmed that an IC chip temperature when the load beam is configured by the Al plate decreases to about 80% suppose that the IC chip temperature is 100% when the load beam is configured by the stainless steel plate.

According to this embodiment, as aforementioned, the temperature of the drive IC chip itself can be decreased and also elevation of the local temperature of the suspension around the drive IC chip can be suppressed. Thus, a stable operation of the drive IC chip can be expected, a thermal deformation of the suspension can be prevented, and a serious heat effect to the thin-film magnetic head element can be prevented. Also, since no additional countermeasure mechanism for enhancing the air cooling effect on the drive IC chip is needed, a sufficient space can be secured between the HGA and the magnetic disk surface. In addition, since the components of the HGA can be fixed to each other by means of the spot welding using a laser beam for example, the manufacturing process will not be complicated and the manufacturing cost can be prevented from increasing.

Although the load beam 14 of Al plate itself has no elasticity for depressing the slider 11 toward the direction of a magnetic disk in operation so as to provide a stable flying height, the hinge 16 substitutes this to provide a load to the slider. Thus, a spring performance as a whole of the suspension will not be deteriorated. Rather, by using Al with a smaller mass density than the stainless steel, a total weight of the suspension can be reduced resulting the mechanical characteristics of the suspension to improve. Also, if the thickness of the Al plate is increased by the reduced amount in weight, more effective thermal radiation can be expected.

The thicker the load beam 14 of Al plate, the larger the thermal capacity and also the higher the thermal conductivity of the HGA. Namely, the thicker the Al plate, the better the heat radiation performance of the HGA causing the IC chip temperature to decrease. However, an excessive thickness of the Al plate causes heavy weight and thus a mechanical characteristics of the suspension is deteriorated. An upper limit of the thickness of the load beam 14 of Al plate is about 500 μm.

Many widely different embodiments of the present invention may be constructed without departing from the spirit and scope of the present invention. It should be understood that the present invention is not limited to the specific embodiments described in the specification, except as defined in the appended claims.

What is claimed is:

1. A suspension comprising:
a resilient flexure made of a stainless steel for supporting a magnetic head slider with at least one thin-film magnetic head element and a drive IC chip with a circuit for said at least one thin-film magnetic head element;
a load beam made of a high-thermal-conductivity material with a higher thermal conductivity than that of the stainless steel, supporting said flexure;
a base plate; and
a hinge made of a stainless steel, fixed to a base section of said load beam and to said base plate, for applying a predetermined load to said magnetic head slider.

2. The suspension as claimed in claim 1, wherein said high-thermal-conductivity material is a metal material containing one of an aluminum, a copper, a magnesium, an aluminum alloy, a copper alloy and a magnesium alloy.

3. A head gimbal assembly comprising:
a magnetic head slider with at least one thin-film magnetic head element;
a drive IC chip with a circuit for said at least one thin-film magnetic head element;
a resilient flexure made of a stainless steel for supporting said magnetic head slider and said drive IC chip;
a load beam made of a high-thermal-conductivity material with a higher thermal conductivity than that of the stainless steel, supporting said flexure;
a base plate; and
a hinge made of a stainless steel, fixed to a base section of said load beam and to said base plate, for applying a predetermined load to said magnetic head slider.

4. The head gimbal assembly as claimed in claim 3, wherein said high-thermal-conductivity material is a metal material containing one of an aluminum, a copper, a magnesium, an aluminum alloy, a copper alloy and a magnesium alloy.
